(19) United States
(12) Patent Application Publication
(10) Pub. No.: US 2007/0118437 A1
(43) Pub. Date: May 24, 2007

(54) PROPERTY PROXIMATE INTERACTIVE SALES KIOSK

(76) Inventor: Jack Perrault, Edmonds, WA (US)

Correspondence Address: AXIOS LAW GROUP, 1725 WESTLAKE AVENUE NORTH, SUITE 150, SEATTLE, WA, 98109, US

(21) Appl. No.: 11/539,154

(22) Filed: Oct. 5, 2006

Related U.S. Application Data
(60) Provisional application No. 60/723,800, filed on Oct. 5, 2005.

(51) Int. Cl. G06Q 30/00

(52) U.S. Cl. 705/26

(57) ABSTRACT

An interactive sales kiosk system. A system may include a number of deployed interactive sales kiosks, each of which is proximate to the property being promoted and communicatively coupled to a remote configuration computer that may be located at a central location. Each interactive sales kiosk may include a display, a local CPU, and a number of peripherals for realizing various applications and functions commonly associated with real-estate and property marketing and sales.

### BACKGROUND OF THE INVENTION

Real-estate agencies and other property sales firms are often called upon to initiate, coordinate, and complete real-estate transaction between individuals and businesses for any number of types of real property including commercial buildings, industrial buildings, residential homes and condominiums. Other significant personal properties, such as a car and boat are also typically offered for sale by agents and businesses on behalf of an owner. As is the case with any property for sale, an agency or firm may typically use a common sign or yard-arm post to advertise that a property is for sale by placing the yard-arm post in the ground on or near the property for sale. Obviously, a conventional yard-arm post is limited to what the agency or firm is able to hang from the arm portion.

For real-estate and other property that is of a high value, agencies and firms often invest more time, money and effort into increasing the profile of the property for sale. Such aggressive and competitive agencies and firms will often use modern technology as a further tool to assist is creating a higher profile property. Such conventional technology typically includes using the Internet with a web page. Using typical web page design, an agency or firm may provide several indoor and outdoor pictures of the property such that a potential buyer may browse properties without having to visit the actual property to gain a better idea of the nature of the property. More advanced web applications allow for a virtual 3-D tour of the property that is rendered from previously recorded pictures and/or video.

A problem exists, however. A potential buyer must be physically at a computer that is connected to the Internet in order to browse a website to take advantage of such web technology. Although portable computers and personal data assistants have greatly increased the mobility of computer-system users, the computing device must still be connected to the Internet in some manner. Thus, while a potential buyer may virtually browse from their home or from an office of the real-estate agency, the potential buyer cannot connect to the Internet at the property listed for sale without establishing a connection to the Internet from within the property, such as through a phone line or local wireless network.

Typically, a potential buyer may happen by a property for sale and notice a yard-arm post in the yard. However, at best, the yard-arm post may only have an agency listing and perhaps a conventional paper advertisement for disbursement in a covered box. There is no way for an agency or firm, however, to provide the potential buyer with the far more appealing and informative web-based media with a simple yard-arm post and the like. That is, access to the relevant and interactive information is simply not proximate to the property offered for sale. Thus, a firm or agency must rely on a potential buyer to make their way to their own Internet connection and then to find their way to the property through their web listing. Such reliance on actions taken away from the potential “point-of-sale” pose a breakdown in the marketing engagement.

### SUMMARY OF THE INVENTION

An embodiment described herein is directed to an interactive sales kiosk system. A system may include a number of deployed interactive sales kiosks, each of which are communicatively coupled to a remote configuration computer that may be located at a central location. Each interactive sales kiosk may include a display, a local CPU, and a number of peripherals for realizing various applications and functions commonly associated with real-estate marketing and sales. Such a proximate interactive sales kiosk provides valuable and interactive information about a property for sale right at the property for sale.

### BRIEF DESCRIPTION OF THE DRAWINGS

The foregoing aspects and many of the attendant advantages of subject matter detailed below will become more readily appreciated as the same become better understood by reference to the following detailed description, when taken in conjunction with the accompanying drawings, wherein:

FIG. 1 is an isometric view of an interactive sales kiosk in accordance with an embodiment of the invention;

FIG. 2 is a block diagram of an interactive real-estate kiosk in accordance with an embodiment of the invention;

FIG. 3 is a block diagram of a system employing a plurality of interactive real-estate kiosks in accordance with an embodiment of the invention; and

FIG. 4 is an isometric view of another interactive sales kiosk in accordance with another embodiment of the invention.

### DETAILED DESCRIPTION

The following discussion is presented to enable a person skilled in the art to make and use the embodiments and descriptions of the subject matter detailed herein. The general principles described herein may be applied to embodiments and applications other than those detailed above without departing from the spirit and scope of the present application. The present application is not intended to be limited to the embodiments shown, but is to be accorded the widest scope consistent with the principles and features disclosed or suggested herein.

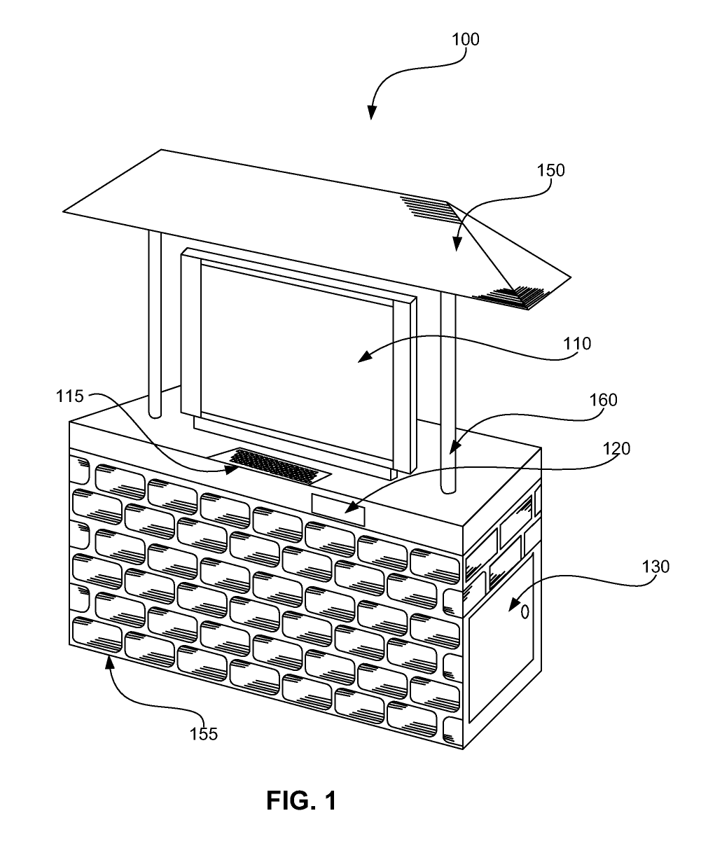

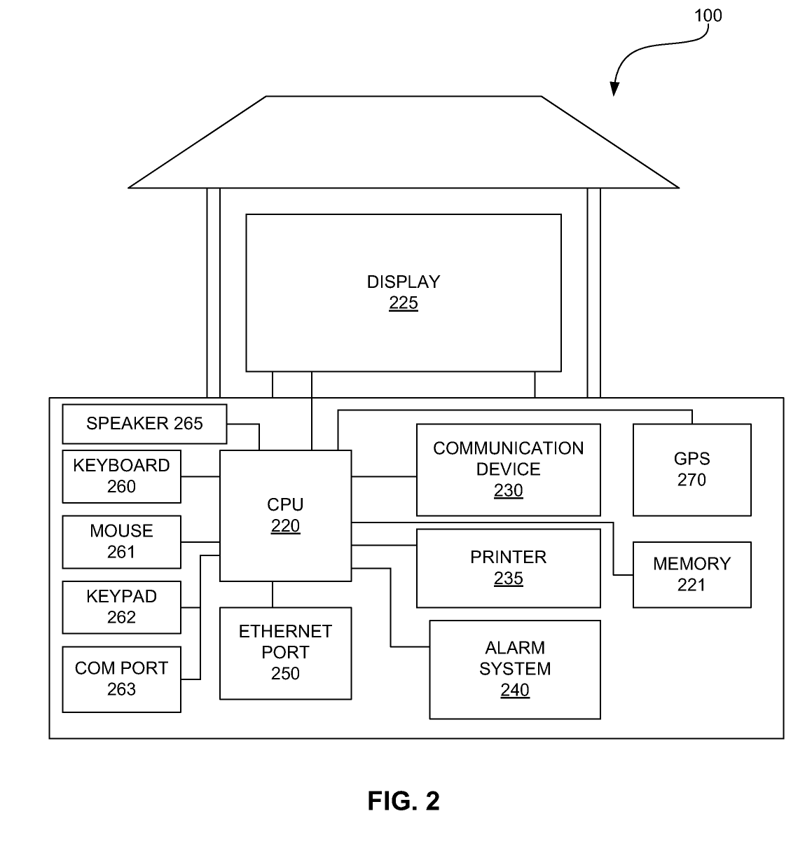

FIG. 1 is an isometric view of an interactive sales kiosk in accordance with an embodiment of the invention. The sales kiosk 100 may be advantageously used for selling property, such as real-estate, cars, boats, or any other piece of property (real or otherwise) in which an owner wishes to promote its sale. In a typical embodiment, the sales kiosk 100 comprises a central processing unit, a memory, and a communication device for uploading and downloading information about the property for sale to and from the sales kiosk 100. With these computer components available to display information about the property for sale on a display 110, the sales kiosk 100 is typically located proximate to the property for sale such that a user may easily receive information about property for sale while at or near the property. These computer components are described in more detail below with respect to FIG. 2.

The interactive sales kiosk 100 also typically includes a viewing display 110 that is mounted to a housing base 155. The kiosk 100 may further include an awning 150 mounted to the base 155 for covering the display 110. The awning 150 is typically weather proof, (e.g., shingled or water-proofed) such that weather elements may be shielded from the display 110 and the base 155 as the sales kiosk 100 will typically be deployed outdoors proximate to a real property (e.g., a house or condominium) that is for sale. The awning 150 is coupled to the base 155 and designed to provide protection to the display 110 from the elements, such as rain, snow, sun and the like. Further, the awning may contain trade names and/or company contact information so as to allow a user to identify the sales kiosk 100 from a distance. The awning 150 may be supported by two poles 160 connected to the base 155. In other embodiments, the awning 150 may be supported by any number of supports emanating from the base 155 including the display 110 itself. The awning 150 may also be other shapes than the shape depicted in FIG. 1.

The base 155 may typically comprise a cavity for housing a number of components for realizing different functions of the kiosk 100. The components are accessible via an access door 130 that is depicted on one side of the base 155. The access door 130 may be located at any side of the base 155 or may be a section of the top of the base 155. The access door 130 is typically lockable using a conventional keyed entry system or alternatively using a keypad for a user to enter a code to gain access.

The base 155 may further include an access port 120 for an output mechanism, such as a printer and the like. The base 155 may further include an external keyboard and mouse bay 115 to allow a user to input data and commands to the kiosk 100. The external keyboard and mouse bay 115 may be configured to house an integrated keyboard and mouse that are coupled to internal components of the kiosk 100.

According to one embodiment of the sales kiosk 100, the base 155 is made of a heavy cement or brick material such that the kiosk 100 is heavy enough to discourage would-be thieves from moving the entire kiosk 100 from a deployed location. A typical weight for the kiosk 100 is 650-800 pounds. The base 155 may further include loopholes and/or eyeholes such that chains or theft-prevention chain-cords may be strung through the base and attached to nearby fixtures. The base 155 may be water-proof and weatherproof and may further include an internal cooling system for maintaining a suitable internal temperature.

According to another embodiment of the sales kiosk 100, the base 155 may include vertical cylindrical cavities (not shown) suitable for mounting the base 155 of the sales kiosk 100 to anchored protruding members emanating from the property in which the sales kiosk 100 is deployed. In such a deployment, a fork lift may be employed to lower the sales kiosk 100 down onto mounting members that are typically metal poles anchored deep into the ground. This type of anchoring mechanism helps prevent theft by requiring the lifting of the entire sales kiosk 100 vertical by about 3 feet before clearing the mounting poles. With this type of quasi-permanent installation, the sales kiosk 100 may also be hard-wired for AC power from a nearby power source, such as a house located at the real property that is for sale.

The display 110 is suitable to display typical information about the property to which it is proximate. The display 110 may typically comprise a Liquid-Crystal Display (LCD) or a plasma screen. In other embodiments, the display 110 may be a conventional cathode ray tube (CRT) or a projection screen. In any embodiment, the display 110 is suited to provide a viewing area for one or more people around the kiosk 100. In further embodiments, a second display 110 facing the opposite direction may also be present or a single display 110 may be double-sided. The display 110 may further provide interactivity such that a user may navigate through the information by touching specific location on the display 110. Such a touch screen allows more flexible user control of the information displayed on the display 110.

FIG. 2 is a block diagram of an interactive sales kiosk 100 in accordance with an embodiment of the invention. This figure shows the afore-mentioned internal components of the kiosk 100. These components include a central processing unit 220 (CPU) operable to execute applications capable of displaying information about the property for sale. The CPU 220 is coupled to a memory 221 and is operable to store information about the property and applications executable by the CPU 220. The CPU 220 is also coupled to a display 225 (same as display 110 is FIG. 1) and is operable to display the information about the real property. Further, the CPU 220 is coupled to a communication device 230 it and is operable to interface with at least one other computer to receive updated information about the real property.

The components described above, including the CPU 220, may be a part of a conventional personal computer or a conventional server computer system. Alternatively, the CPU 220 may be a dedicated computing platform for providing very specific application programmability to the kiosk 100. As such, the CPU 220 is generally associated with a processor, a communication bus, memory and input/output peripherals, some of which are not shown for ease of illustration. Such peripherals devices include the display 225 for displaying many sorts of data to a user and a printer 235 for printing data for a user. Another device, as mentioned above, may include a keyboard 260 or a mouse 261 anchored to a keyboard bay 115. Additional devices include a keypad 262 for entering numerical data and a speaker system 265 operable to play audio signals concurrent with information being displayed on the display 225.

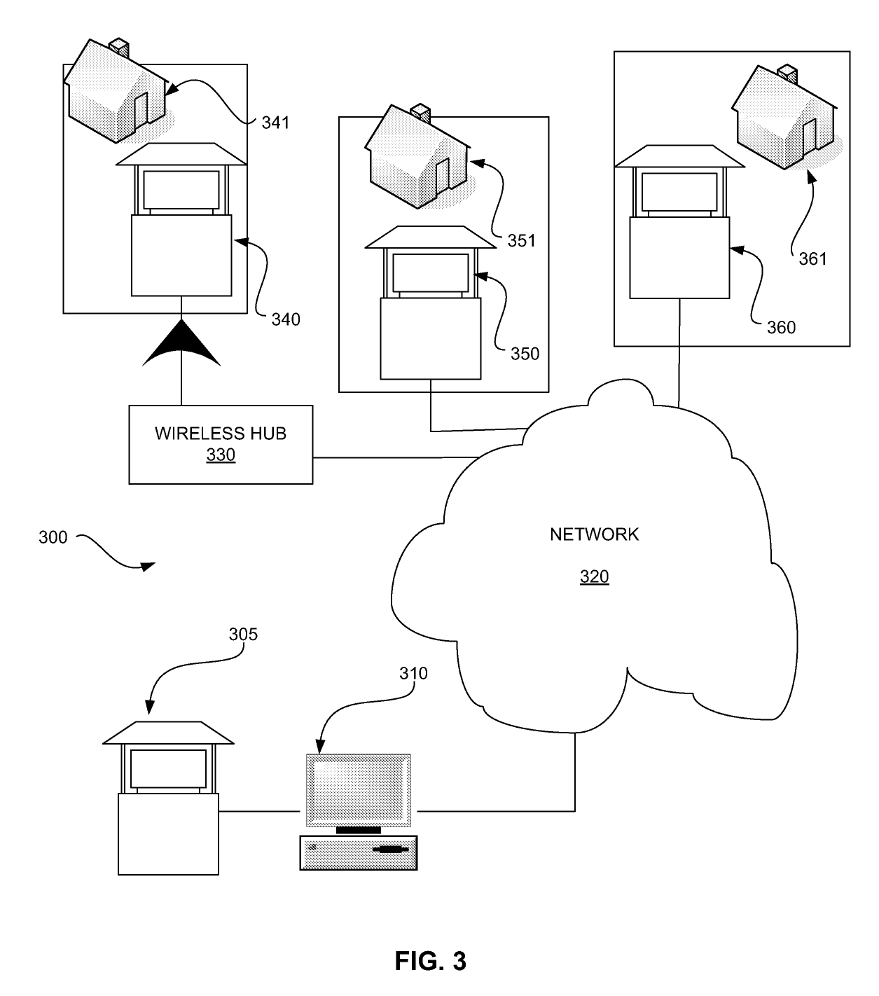

The kiosk 100 may further include an Ethernet port 250 for facilitating network communication between the kiosk 100 and a central computing system (described below with respect to FIG. 3) via standard network protocols such as TCP/IP. The Ethernet port 250 may be wireless or otherwise and may typically be coupled to the Internet, a privately-facilitated intranet, or a virtual private network. Data may be downloaded or uploaded to and from the kiosk 100 via the Ethernet port 250.

The CPU 220 may be generally configured to provide a platform for implementing a number of applications associated with real estate and property sales. For example, the kiosk 100 may be configured to display several pictures of a property offered for sale. The kiosk may further include a virtual 3-D tour of the property, information about the neighborhood, maps of the area, topographical maps of the property, tax assessment information, and the like. The information may be updatable and configurable remotely via communication devices as described below.

The communication device 230 may typically be a wireless communication device for facilitating wireless communication between the kiosk 100 and a central computing system (depicted in FIG. 3). The wireless communication device may also include a Bluetooth-enabled device for communicating with other Bluetooth-enabled devices that may be in close proximity to the kiosk 100. Data may be downloaded or uploaded to and from the kiosk 100 via the wireless communication device 230.

The kiosk 100 may further include an alarm system 240 configured to detect motion of the kiosk 100 or an off-balanced kiosk 100 and configurable to send a notification email or phone call in an effort to indicate movement or damage. The alarm system 240 may also play a loud audible sound through the speaker system 265 indicating movement or tampering. The alarm system 240 may further include a theft-recovery device, such as a Lo-Jack™ recovery system. Additional security and functionality may be realized through a global positioning system 270 (GPS) that may be configured to be tracked by a remote device or system and through a gyrometer-based motion detector system, an accelerometer based system, and a motion detection system.

FIG. 3 is a block diagram of a system 300 employing a plurality of interactive sales kiosks in accordance with an embodiment of the invention. The system 300 may typically comprise at least one kiosk 340 located proximate to the property 341 being sold and a server computer 310 communicatively coupled to the kiosk 340 and operable to automatically update the information stored in the memory.

The system 300 utilizes the remote configuration computer 310 i.e., a server computer 310 wherein the server computer 310 is communicatively coupled to a number of kiosks in the deployed system 300. For example, a local kiosk 305 may be coupled directly to the remote configuration computer 310. Further, a wireless kiosk 340 may coupled to the remote configuration computer 310 via a network 320 and a wireless hub 330. Still further, other kiosks 350 and 360 may be coupled to the remote configuration computer 310 via just the network 320.

Having a system 300 with a number of deployed kiosks all communicatively coupled to a remote configuration computer 310 allows a real estate agency to update data at a number of kiosks remotely from a central office location. Further, data requests and other information may be sent from a deployed kiosk to the real-estate office, such as a request for an agent to show a property. One or more of the kiosks are typically deployed proximate to the property which is being promoted thereon. Thus, kiosk 340 is located on or near the property/house 341 (i.e., proximate to). Likewise, kiosk 350 is proximate to house 351 and kiosk 360 is proximate to house 361. As used herein, a kiosk located on or within a typical walking distance of the property being sold is considered to be proximate to the property being sold.

Having a sales kiosk 340 proximate to the property 341 being sold is advantageous because potential buyers need not have a remote connection to the Internet and the like in order to garner information about the property being sold. Additionally, the kiosk 340 may provide a communications hub such that a potential buyer may learn additional information about the property, email directly to an agent, or download information for printing or data transfer to a cell phone, a PDA, etc. via wireless Bluetooth and such.

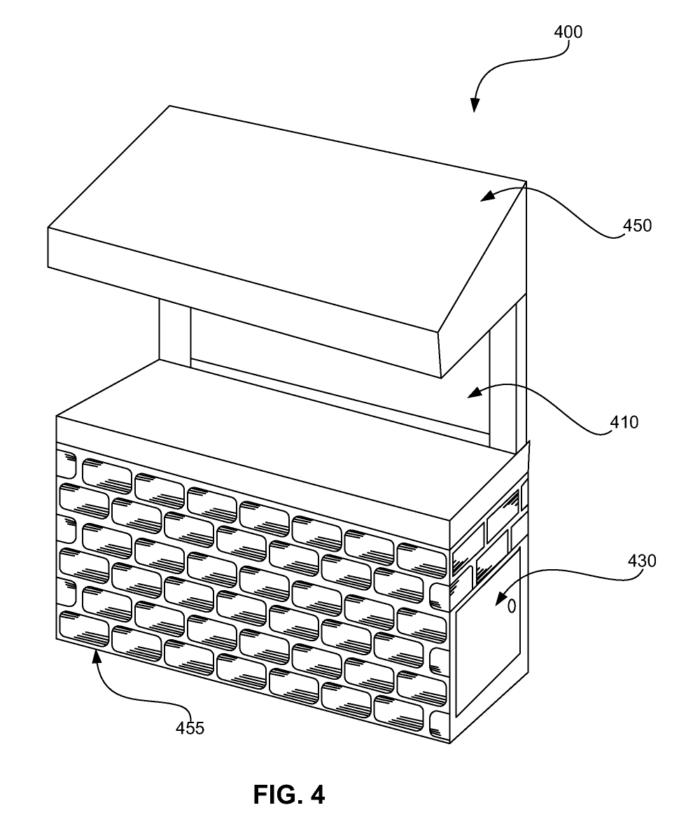

FIG. 4 is an isometric view of another interactive sales kiosk 400 in accordance with another embodiment of the invention. The interactive sales kiosk 400 also typically includes a viewing display 410 that is mounted to a housing base 455. The kiosk 400 may further include an awning 450 mounted to the base 455 and the display 410 for covering the display 110. The awning 450 is typically weather proof, (e.g., shingled or water-proofed) such that weather elements may be shielded from the display 410 and the base 455 as the sales kiosk 400 will typically be deployed outdoors. Further, the awning may contain trade names and/or company contact information so as to allow a user to identify the sales kiosk 400 from a distance.

While the embodiments disclosed are susceptible to various modifications and alternative constructions, certain illustrated embodiments thereof are shown in the drawings and have been described above in detail. It should be understood, however, that there is no intention to limit the subject matter to the specific forms disclosed, but on the contrary, the intention is to cover all modifications, alternative constructions, and equivalents falling within the spirit and scope of the specification.

What is claimed is:

1. A system for promoting property, the system comprising:
a kiosk located proximate to the property, the kiosk including:
a processing unit operable to execute applications capable of displaying information about the property;
a memory coupled to the processing unit, the memory operable to store information about the property;
a display coupled to the processing unit and operable to display the information about the real property; and
a communication device coupled to the processing unit and operable to interface with at least one other computer to receive updated information about the real property; and
a server computer communicatively coupled to the kiosk and operable to automatically update the information stored in the memory.

2. The system of claim 1 wherein the property for sale is real property and wherein the kiosk proximate to the property comprises anchoring the kiosk to the real property.

3. The system of claim 1 wherein the kiosk only maintains information the property to which it is proximate.

4. The system of claim 1 wherein the kiosk and the server are communicatively coupled via a networked computer system such that the kiosk transmits and receives data via a wireless network connection.

5. The system of claim 1, further comprising at least one other kiosk communicatively coupled to the server computer such that the at least one other kiosk is proximate to at least one other property offered for sale and such that the server computer is operable to update the at least one other kiosk with information about the at least one other property.

6. A method for providing information about a property for sale, the method comprising:
anchoring a kiosk for promoting property proximate to the property that is for sale; downloading information about the property for sale from a server computer communicatively coupled to the kiosk, the downloaded information stored in a memory in the kiosk;
displaying the information about the property for sale on a display.

7. The method of claim 6, further comprising updating the information about the property for sale by downloading new information from the server computer.

8. The method of claim 6, further comprising initiating a sequence of displayed information when an interactive input device is actuated.

9. A kiosk for promoting property, the kiosk comprising:
a processing unit operable to execute applications capable of displaying information about the property;
a memory coupled to the processing unit, the memory operable to store information about the property;
a display coupled to the processing unit and operable to display the information about the real property; and
a communication device coupled to the processing unit and operable to interface with at least one other computer to receive updated information about the real property;
wherein the kiosk is located proximate to the property.

10. The kiosk of claim 9, further comprising an awning that is operable to provide protection from weather elements for the kiosk.

11. The kiosk of claim 9, further comprising a base housing operable to enclose the processing unit and operable to support the display.

12. The kiosk of claim 10 wherein the base comprises a concrete structure having a weight of at least 600 pounds.

13. The kiosk of claim 10, further comprising a lockable access door in the base housing operable to provide access inside the base housing.

14. The kiosk of claim 9, wherein the display comprises a display selected from the group including: a plasma display, a liquid-crystal display, and a cathode-ray tube display.

15. The kiosk of claim 9, wherein the display comprises a touch-sensitive display such that a user may affect the information displayed on the display by touching the screen and navigating between different displays of information.

16. The kiosk of claim 9, further comprising a device from the group including:
a keyboard coupled to the processing unit operable to provide input to the processing unit;
a communication port coupled to the processing unit operable to provide a communicative link between the processing unit and a portable media;
an audio speaker system coupled to the processing unit and operable to playback audio information about the property;
a printer coupled to the processing unit operable to print information displayed on the display;
a pointing device coupled to the processing unit;
a wireless communication device coupled to the processing unit; and
a wireless Ethernet port coupled to the processing unit.

17. The kiosk of claim 9, further comprising a second display coupled to the processing unit and operable to display information about the property.

18. The kiosk of claim 9, further comprising a theft-prevention device from the group including an audible alarm system, a global positioning system, a Lo-Jack anti-theft device, a gyrometer-based motion detector system, an accelerometer based system, and a motion detection system.

19. The kiosk of claim 9, further comprising an interactive input device operable to initiate a specified sequence of displayed information the display.

20. The kiosk of claim 9, further comprising an AC power interface coupled to the processing unit and operable to facilitate an electrical coupling between the kiosk and a source of AC power at the property.
